(19) United States
(12) Patent Application Publication
(10) Pub. No.: US 2025/0390313 A1
(43) Pub. Date: Dec. 25, 2025

(54) DOMAIN AGNOSTIC SYSTEM CONFIGURATION

(71) Applicant: Red Hat, Inc., Raleigh, NC (US)

(72) Inventors: Adam John Miller, Austin, TX (US); Pierre-Yves Chibon, Puteaux (FR)

(21) Appl. No.: 18/749,033

(22) Filed: Jun. 20, 2024

(51) Int. Cl. G06F 9/445

(52) U.S. Cl. CPC G06F 9/44505

(57) ABSTRACT

A method includes receiving a state declaration associated with a target computing system, wherein the state declaration is in a standard format, translating the state declaration into configuration operations associated with the target computing system, generating a set of scripts to perform the configuration operations on the target computing system, and deploying the set of scripts to the target computing system to configure the target computing system according to the state declaration.

### TECHNICAL FIELD

Aspects of the present disclosure relate to configuration of virtualized computing systems, and more particularly, translating a defined configuration notation to another cloud native system configuration.

### BACKGROUND

Configuration management technology includes software for maintaining computer systems in a consistent and desirable state. Such configuration management can include tracking and managing an organization's software and hardware assets to ensure they are working optimally and are up to date. Configuration management tools can provide an automated framework for executing configuration management according to a desired state of the system defined by a user.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a system diagram that illustrates an example system for automatic application of a state declaration, in accordance with some embodiments.

FIG. 2 is a block diagram that illustrates another example of a system for translation of a state definition into a set of scripts for automatic application of the state declaration, in accordance with embodiments of the disclosure.

FIG. 3 is a block diagram of an example computing system for automatic translation and application of a state declaration, in accordance with some embodiments.

FIG. 4 is a flow diagram of a method of automatic application of a state declaration to a target computing system, in accordance with some embodiments.

FIG. 5 depicts a flow diagram of another method of translation and application of a state declaration to a target computing system, in accordance with some embodiments.

FIG. 6 is a block diagram of an example apparatus that may perform one or more of the operations described herein, in accordance with some embodiments of the present disclosure.

### DETAILED DESCRIPTION

Infrastructure automation and configuration management systems operate to provide a consistent operational state of a computing system, often a distributed computing system. For example, a computing system may include configurations and processes that are managed by infrastructure automation and configuration management systems as defined by one or more rules provided to the systems. However, in conventional infrastructure automation and configuration management systems, state declaration is done in a vendor specific or domain specific language, format, etc. Accordingly, each system necessitates domain specific or vendor specific knowledge and expertise to properly define the state declarations. The requirement of domain specific knowledge creates a burden on information technology and operational technology operations teams that have to interface and reasons with multiple different vendor specific methods just to accomplish simple management tasks because the teams may have to constantly learn new management systems over time. Additionally, the teams may further utilize modern Cloud Native environments in which they have to understand and reason with a system state using a non-native methodology.

Aspects of the disclosure address the above-noted and other deficiencies by providing a translation layer between a standardized or common state declaration format (e.g., ConfigMap™ of Kubernetes™) and the automation systems (e.g., Ansible™) to automatically generate and apply a set of scripts for configuring various computing systems. In some embodiments, the translation layer may include a translation engine that receives a state declaration in the standard format. The translation engine may identify the computing system and the programming language used by the computing system. The translation engine may then determine a method of translating the state declaration to a set of scripts for configuring the computing system according to the configurations defined by the standard state declaration.

In some embodiments, the translation engine may include several modules defining scripts and operations (e.g., for a particular domain, vendor, etc.) associated with each of the possible objects, definitions, and configurations of the standard state declaration format. Accordingly, the translation engine may identify the module associated with the identified computing system and programming language to use the corresponding module for translation. For example, for each definition in the provided state declaration the translation engine may determine, from the identified module, one or more automated scripts to perform on the computing system to provide the configuration from the definition in the state declaration.

In some embodiments, the translation engine may include a machine learning model trained on labeled data including various state declarations in a standard format and a resulting or corresponding set of scripts for one or more computing systems with domain specific languages. Therefore, the machine learning model may be trained to infer a set of scripts for configuring a computing system based on the definitions within a state declaration in a standard format.

By providing the translation engine in the automation pipeline for configuration management, embodiments described herein provide a vendor agnostic and domain agnostic representation of configuration state for infrastructure artifacts in a way that is cloud native but that extends to technologies in the infrastructure that are not cloud native. Thus, a single defined contract interface is provided to manage all aspects of an infrastructure, reducing the required domain and vendor specific knowledge for configuration. Additionally, incorporating the translation from the single defined contract interface provides for reduced time for deployment and configuration of architectures and reduces the complexity of such deployments.

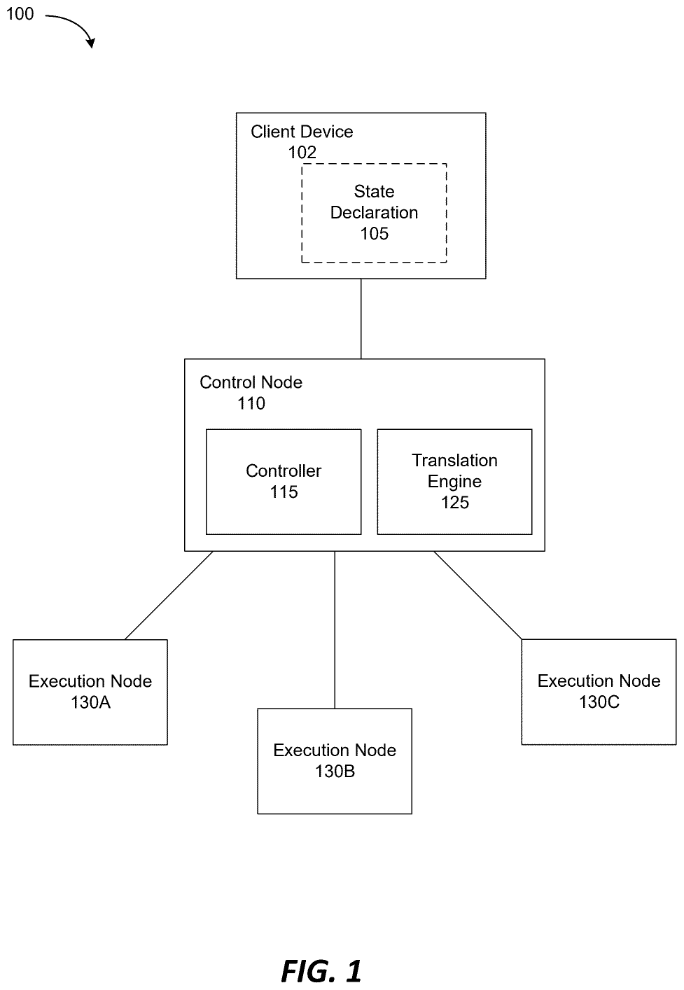

FIG. 1 is a block diagram illustrating a system 100 for automated translation and application of computing architecture configurations from a standard state declaration format. System 100 includes a client device 102 at which a user may provide a state declaration 105 in a standardized format, such as a ConfigMap as provided by the Kubernetes platform for architecture definition. The client device 102 may be a server, a mainframe, a workstation, a personal computer (PC), a mobile phone, a palm-sized computing device, or any other computing device. The system 100 further includes one or more virtual or hardware computing nodes. In some embodiments, the system 100 includes a control node 110 and one or more execution nodes 130A-C which may operate as a virtual mesh overlay for distributing scripts or configuration instructions to a computing architecture. For example, control node 110 may include a controller 115 for job scheduling, managing workflows, and providing high order automation and orchestration for a target computing system.

In some embodiments, the control node 110 may be an automation platform for generating and managing configurations of a computing system infrastructure. As discussed above, the control node may include a controller 115 for communicating with and managing distribution of automation scripts to execution nodes 130A-B. Control node 110 and execution nodes 130A-C may each be a virtual computing environment (e.g., container, virtual machine, etc.) or hardware computing device such as a server, a mainframe, a workstation, a personal computer (PC), a mobile phone, a palm-sized computing device, or any other computing device. In addition, control node 110 may include a translation engine 125 for providing the controller 115 with domain specific rules or configuration operations to be applied to host nodes of the computing system based on the state declaration 105 provided by the client device 102. In some embodiments, the translation engine 125 may receive the state declaration 105 from the client device 102 and identify definitions or statements provided by the state declaration 105. The translation engine 125 may further identify corresponding rules or configuration operations that apply to the particular target host system for each of the definitions or statements provided by the state declarations 105.

In some examples, the translation engine 125 may include one or more modules, each associated with a particular domain, language, vendor, etc. The translation engine 125 may identify the module or modules corresponding to the target host system and apply the rules of the module or modules to the statements of the state declaration. In some examples, the translation engine 125 may map each statement or a set of statements in the state declaration 105 to one or more configuration operations or instructions to be performed on the target system in order to provide the state defined by the statement or statements of the state declaration 105. Accordingly, by identifying the configuration operations to be performed on the target host for each statement or each relevant statement of the state declaration 105, the translation engine 125 may generate, or cause the controller 115 to generate, a set of scripts (e.g., an Ansible module) for performing the identified configuration operations at the target system. The controller 115 may provide the generated set or sets of scripts to an execution node (e.g., execution node 130A, 130B, or 130C) to deploy the scripts to the target system for configuration in accordance with the state declaration 105. Although specific examples provided herein refer to a ConfigMap state declaration and example automation system Ansible, embodiments may operate with any state declaration format and within any automation system.

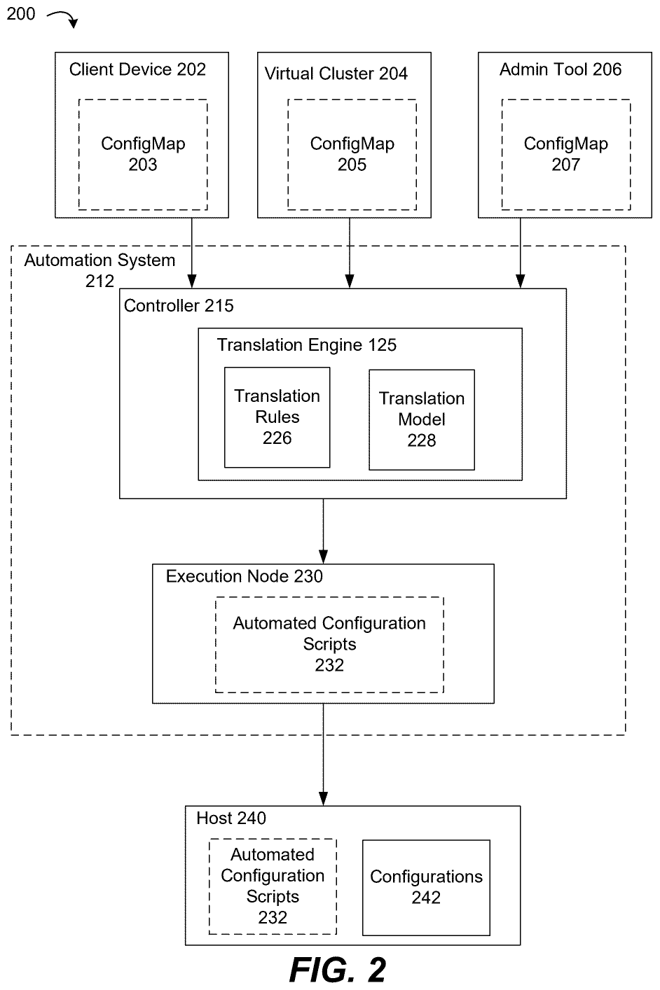

FIG. 2 is a block diagram that illustrates a system for translation of a state declaration for a computing system to provide vendor and domain agnostic configuration management 200, according to some embodiments. As depicted, system 200 includes client device 202, virtual cluster 204, an admin tool 206, and so forth. The client device 202 may be a virtual machine, container, server, a mainframe, a workstation, a personal computer (PC), a mobile phone, a palm-sized computing device, or any other virtual or hardware computing device. The virtual cluster 204 may be a collection of virtual resources including one or more containers, one or more virtual machines, and any other virtual processing devices. The admin tool 206 may be an interface for providing high level management and configuration instructions to an automation system.

In some embodiments, each of the client device 202, the virtual cluster 204, and the admin tool 206 may define or generate a state declaration in a standard format, such as a ConfigMap (e.g., ConfigMaps 203, 205, and 207). Each ConfigMap may be generated for a target system, such as host 240. In some examples, host 240 may be a legacy system, non-cloud native system, or otherwise have a vendor specific or domain specific configuration language or format. For example, host 240 may be a legacy Red Hat Enterprise Linux system which is non-cloud native and therefore is generally not compatible with direct application of ConfigMap state declarations. Accordingly, system 200 provides a translation engine 125 in an infrastructure automation system 212 to convert a widely used abstract state declaration, such as ConfigMaps, into domain specific configuration operations. In some embodiments, the translation engine 125 may be incorporated in a controller 215 of the automation system 212. In some examples, the translation engine 125 may be provided separate from the controller 215 within the automation system and may be in communication with the controller 215. For example, the output of the translation engine 125 may be provided to the controller 215 for generation of automation scripts for configuring a target system (e.g., host 240).

In some examples, the automation system 212 may receive ConfigMaps 203, 205, and 207, and convert them into corresponding automation scripts for configuring and managing one or more target computing systems. In some embodiments, the translation engine 125 of the automation system 212 may receive each ConfigMap and identify the target system to which the ConfigMap is to be applied. Based on the identified target system, the translation engine 125 may determine one or more translation rules 226 that apply to the statements provided in the ConfigMap. For example, each statement or a set of statements may correspond to or map to one or more translation rules 226. The translation rules 226 may identify the configuration steps or operations that are necessary to be performed on the target system (e.g., host 240) to provide the configuration state indicated by the statements of the ConfigMap.

In some embodiments, the translation engine 125 may include a translation model 228 in addition to, or as an alternative to, the translation rules 226. Translation model 228 may be a machine learning model that is trained on labeled configuration data and ConfigMaps in order to infer configuration steps or operations for a target system based on an input ConfigMap. For example, a set of training data for the translation model 228 may include various ConfigMaps and configuration operations for a target system that have previously been determined to correspond to the statements provided a corresponding ConfigMap. In other words, the training data may include a set of data that includes ConfigMaps and a set of instructions identified manually or otherwise, that apply the statements of the ConfigMaps to a particular target system or various target systems.

Once the translation engine 125 determines the configuration operations for the target system, the controller 215 may generate one or more automated configuration scripts 232 that implement the configuration operations identified by the translation engine 125 on the target system. The controller 215 may then provide the automated configuration scripts 232 to an execution node 230 of an automation mesh of the automation system 212. The execution node 230 may be a virtual environment of the mesh that is assigned to, in proximity to, or otherwise associated with, the target system (e.g., host 240). The execution node 230 may be in communication with the host 240 via a network (e.g., a public network (e.g., the internet), a private network (e.g., a local area network (LAN) or wide area network (WAN)), or a combination thereof). The execution node 230 may provide the automated configuration scripts 232 to the host 240 for execution. Upon executing the automated configuration scripts by the host 240, the host 240 may be configured with configuration 242 that satisfy the state declaration provided by the ConfigMap or ConfigMaps (e.g., ConfigMap 203, 205, or 207) defined for the host 240.

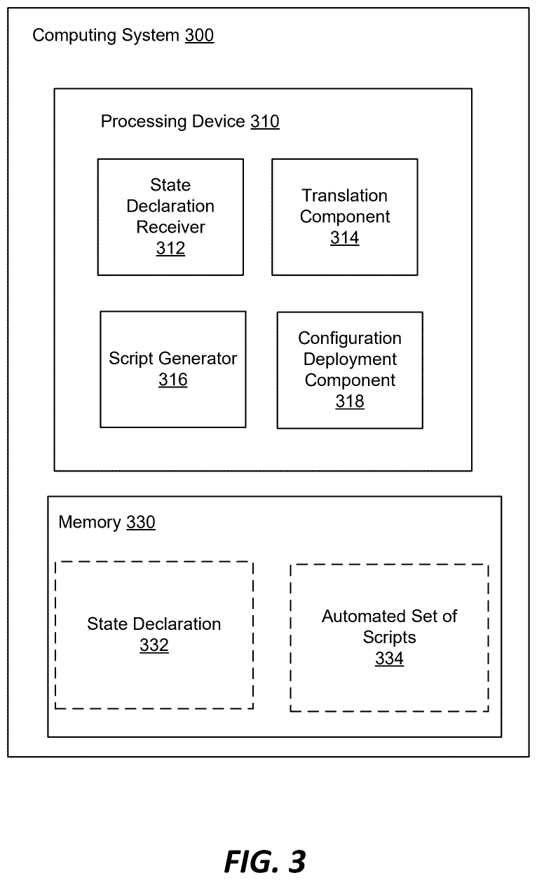

FIG. 3 is a block diagram illustrating a computing system 300 for testing a containerized application, according to some embodiments. Computing system 300 includes processing device 310 and memory 330. Memory 330 may include volatile memory devices (e.g., random access memory (RAM)), non-volatile memory devices (e.g., flash memory) and/or other types of memory devices.

The processing device 310 may be provided by one or more general-purpose processing devices such as a microprocessor, central processing unit, or the like. In some embodiments, processing device 310 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 302 may include one or more special-purpose processing devices such as an application specific integrated circuit (ASIC), a field programmable gate array (FPGA), a digital signal processor (DSP), network processor, or the like. The processing device 310 may be configured to execute the operations described herein, in accordance with one or more aspects of the present disclosure, for performing the operations and steps discussed herein. For example, processing device 310 may execute a state declaration receiver 312, a translation component 314, a script generator 316, and a configuration deployment component 318.

In one example, state declaration receiver 312 receives a state declaration 332 from a client device or other interface for defining a system state. The state declaration 332 may be a commonly used or standard format, such as a ConfigMap associated with cloud-native systems. The state declaration 332 may include one or more statements or sets of statements defining a configurational or operational state of a target computing system. The target computing system may be any type of computing system manageable by an automation system (e.g., configuration management system or architecture automation system, such as Ansible™, Puppet™, SaltStack™, etc.). In some embodiments, the target system may be a legacy system such as a non-cloud native computing system (e.g., local computing architecture). In some embodiments, translation component 314 may then translate the state declaration 332 into a set of configuration operations associated with the target system. For example, the configuration operations for the target system may be different than the configuration operations for a different target system or a cloud-native system. Therefore, the translation component 314 may identify the statements provided by the state declaration 332 (e.g., defining a configuration) and determine which steps would be taken on the target system in order to obtain the configuration defined by the state declaration. In some examples, the translation component 314 may identify a module or a set of rules for translating the state declaration into the configuration operations for the target system. In some examples, the set of rules may include an association or mapping of the statements or sets of statements defined in the state declaration 332 to one or more configuration steps or operations of the target system.

In some embodiments, the script generator 316 may receive the configuration operations for the target system determined by the translation component 314. The script generator 316 may generate a set of automated scripts 334 that may be executed on the target system to perform the configuration operations and to obtain a configuration of the target system that complies with the state declaration 332. The configuration deployment component 318 may then deploy the set of automated scripts 334 to the target system. For example, the configuration deployment component 318 may provide the set of automated scripts 334 to an automation mesh which may provide the scripts 334 to an execution node associated with the target system. The execution node of the automation mesh may apply the set of automated scripts to the target system (e.g., over a network). Thus, the set of automated scripts 334 may apply the configuration operations to the target system and configure the target system in accordance with the state declaration 332.

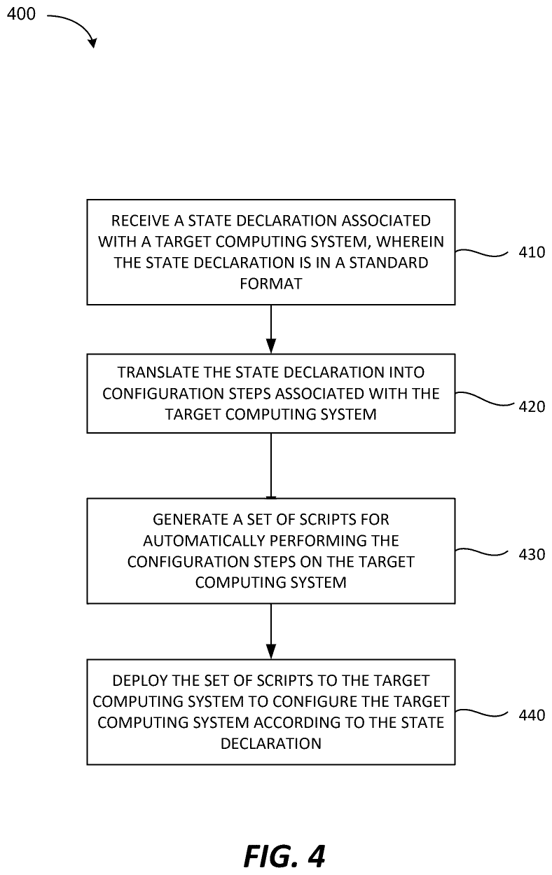

FIG. 4 is a flow diagram of a method 400 of automatic application of a state declaration to a target computing system, in accordance with some embodiments. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by translation engine 125 of FIGS. 1 and 2.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Method 400 begins at block 410, where the processing logic receives a state declaration associated with a target computing system, wherein the state declaration is in a standard format. In some embodiments, the standard format of the state declaration includes a format associated with a cloud native architecture. For example, the standard format of the state declaration may include a ConfigMap state declaration for a cloud native system, such as Kubernetes. In some examples, the target system includes a legacy computing system or a non-cloud native computing system.

At block 420, the processing logic translates the state declaration into configuration operations associated with the target computing system. In some embodiments, to translate the state declaration the processing logic determines configuration rules of the target computing system associated with each statement, definition, or set of statements provided by the state declaration and translates the state declaration based on the configuration rules for each statement, definition, or set of statements of the state declaration. In some examples, to translate the state declaration, the processing logic provides the state declaration to a machine learning model trained to infer the set of configuration operations based on statements provided by the state declaration.

At block 430, the processing logic generates a set of scripts to perform the configuration operations on the target computing system. In some embodiments, the set of scripts may include instructions for performing the configuration operations automatically (e.g., without user intervention) at the target computing system. At block 440, the processing logic deploys the set of scripts to the target computing system to configure the target computing system according to the state declaration. In some embodiments, to deploy the set of scripts to the target computing system, the processing logic distributes the set of scripts to an execution node of an automation system associated with the target computing system and causes, by the execution node, the set of scripts to be executed by the target computing system.

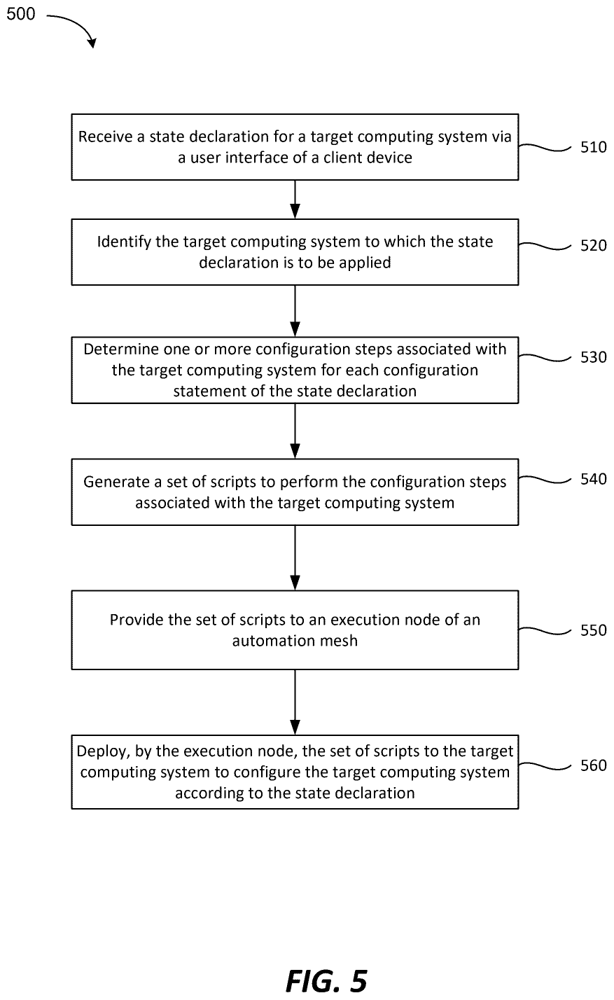

FIG. 5 is a flow diagram of a method 500 of translation and application of a state declaration to a target computing system, in accordance with some embodiments. Method 500 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by automation system 212 and translation engine 125 of FIG. 2.

With reference to FIG. 5, method 500 illustrates example functions used by various embodiments. Although specific function blocks (“blocks”) are disclosed in method 500, such blocks are examples. That is, embodiments are well suited to performing various other blocks or variations of the blocks recited in method 500. It is appreciated that the blocks in method 500 may be performed in an order different than presented, and that not all of the blocks in method 500 may be performed.

Method 500 begins at block 510, where the processing logic receives a state declaration for a target computing system via a user interface of a client device. The state declaration may be a common or standard format. For example, because cloud-native platforms have become pervasive and are commonly used to provide large environments and infrastructures, the formats and method for configuring such cloud-native platforms have become increasingly common. However, these formats and methods for cloud-native platforms may not be applicable to legacy systems or non-cloud native systems. Accordingly, the standard state declaration may be in a cloud-native format that is commonly used, such as ConfigMaps, such that a vendor, domain, and language agnostic state declaration may be used for configuring various systems.

At block 520, the processing logic identifies the target computing system to which the state declaration is to be applied. In some examples, the processing logic identifies a type of the target computing system and various other information about the target system. For example, the processing logic may determine the hardware, the operating system, the foundational or compatible programming languages, and any other information that may be relevant for determining how configurations are applied within the target system.

At block 530, the processing logic determines one or more configuration steps or operations associated with the target computing system for each configuration statement of the state declaration. In some examples, the processing logic may access a set of rules (e.g., a module) for translating the statements of the state declaration to configuration operations of the target system that satisfy the statements of the state declaration. For example, a set of rules or modules may be determined and associated with each potential type of target computing system (e.g., for different hardware, operating systems, programming languages, etc.). Therefore, the processing logic may select one or more module from the various modules that correspond to the identified target system and the type of the identified target system.

At block 540, the processing logic generates a set of scripts to perform the configuration operations associated with the target computing system. In some embodiments, the set of scripts may include a module of an automation system, such as Ansible, for automatic application of configuration and state management. The set of scripts may codify the configuration operations for the target system that were previously translated and identified from the statements within the state declaration.

At block 550, the processing logic provides the set of scripts to an execution node of an automation mesh. For example, the automation system may include an automation mesh including a network overlay for an infrastructure that performs automated job scheduling. In some embodiments, the automation system may schedule set of scripts as a job distributed to the execution node. At block 560, the processing logic deploys, by the execution node, the set of scripts to the target computing system to configure the target computing system according to the state declaration. The execution node may be in communication with the target system via a network and communicate the set of scripts to the target system to be executed by the target system. Thus, the set of scripts may cause the target system to perform the configuration operations identified based on the state declaration.

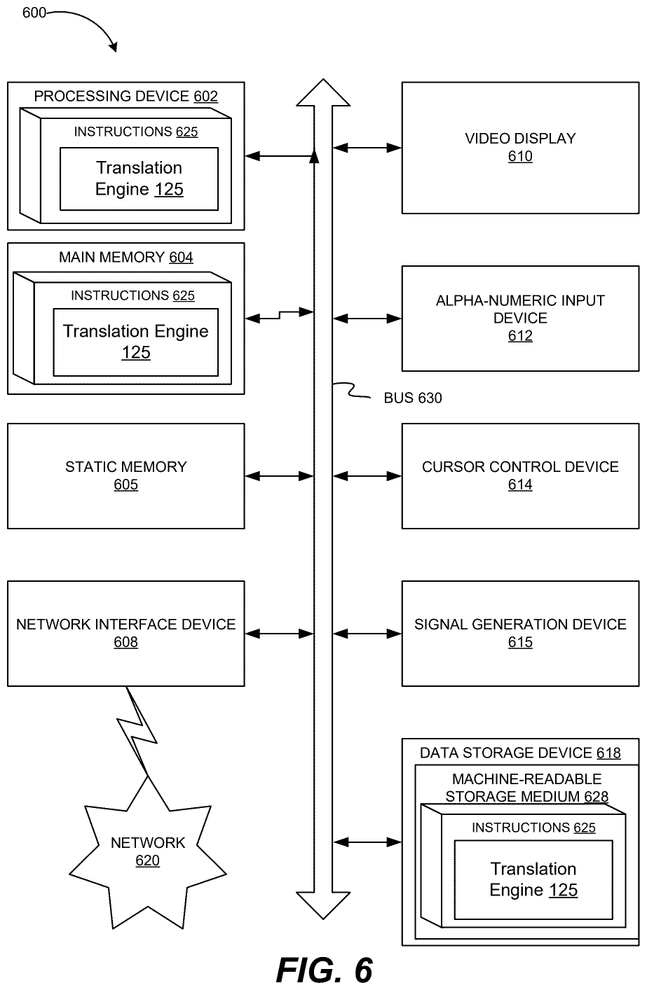

FIG. 6 is a block diagram of an example computing device 600 that may perform one or more of the operations described herein, in accordance with some embodiments. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general purpose processor, a PLD, etc.) 602, a main memory 604 (e.g., synchronous dynamic random access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also comprise one or more special-purpose processing devices such as an application specific integrated circuit (ASIC), a field programmable gate array (FPGA), a digital signal processor (DSP), network processor, or the like. The processing device 602 may be configured to execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a computer-readable storage medium 628 on which may be stored one or more sets of instructions 625 that may include instructions for translation engine, e.g., translation engine 125 of FIGS. 1 and 2, for carrying out the operations described herein, in accordance with one or more aspects of the present disclosure. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a network 620 via network interface device 608. Embodiments may further include a computer program product including instructions 625 that, when executed by a processor (e.g., processing device 602), implement the translation engine 125 described herein.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “translating,” “generating,” “deploying,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
receiving a state declaration associated with a target computing system, wherein the state declaration is in a standard format;
translating, by a processing device, the state declaration into configuration operations associated with the target computing system;
generating a set of scripts to perform the configuration operations on the target computing system; and
deploying the set of scripts to the target computing system to configure the target computing system according to the state declaration.

2. The method of claim 1, wherein translating the state declaration to the configuration operations for the target computing system comprises:
determining configuration rules of the target computing system associated with each definition provided by the state declaration; and
translating the state declaration based on the configuration rules for each definition of the state declaration.

3. The method of claim 1, wherein the standard format of the state declaration comprises a format associated with a cloud native architecture.

4. The method of claim 1, wherein the standard format of the state declaration comprises a ConfigMap state declaration.

5. The method of claim 1, wherein translating the state declaration to the set of configuration operations for the target computing system comprises:
providing the state declaration to a machine learning model trained to infer the set of configuration operations based on statements provided by the state declaration.

6. The method of claim 1, wherein the target computing system comprises a legacy computing system or a non-cloud native computing system.

7. The method of claim 1, wherein deploying the set of scripts to the target computing system comprises:
distributing the set of scripts to an execution node of an automation system associated with the target computing system; and
causing, by the execution node, the set of scripts to be executed by the target computing system.

8. A system comprising:
a memory; and
a processing device operatively coupled to the memory, the processing device to:
receive a state declaration associated with a target computing system, wherein the state declaration is in a standard format;
translate the state declaration into configuration operations associated with the target computing system;
generate a set of scripts to perform the configuration operations on the target computing system; and
deploy the set of scripts to the target computing system to configure the target computing system according to the state declaration.

9. The system of claim 8, wherein to translate the state declaration to the configuration operations for the target computing system, the processing device is to:
determine configuration rules of the target computing system associated with each definition provided by the state declaration; and
translate the state declaration based on the configuration rules for each definition of the state declaration.

10. The system of claim 8, wherein the standard format of the state declaration comprises a format associated with a cloud native architecture.

11. The system of claim 8, wherein the standard format of the state declaration comprises a ConfigMap state declaration.

12. The system of claim 8, to translate the state declaration to the configuration operations for the target computing system, the processing device is to:
provide the state declaration to a machine learning model trained to infer the set of configuration operations based on statements provided by the state declaration.

13. The system of claim 8, wherein the target computing system comprises a legacy computing system or a non-cloud native computing system.

14. The system of claim 8, wherein to deploy the set of scripts to the target computing system, the processing device is to:
distribute the set of scripts to an execution node of an automation system associated with the target computing system; and
cause, by the execution node, the set of scripts to be executed by the target computing system.

15. A non-transitory computer-readable storage medium including instructions that, when executed by a processing device, cause the processing device to:
receive a state declaration associated with a target computing system, wherein the state declaration is in a standard format;
translate, by the processing device, the state declaration into configuration operations associated with the target computing system;
generate a set of scripts to perform the configuration operations on the target computing system; and
deploy the set of scripts to the target computing system to configure the target computing system according to the state declaration.

16. The non-transitory computer-readable storage medium of claim 15, wherein to translate the state declaration to the configuration operations for the target computing system, the processing device is to:
determine configuration rules of the target computing system associated with each definition provided by the state declaration; and
translate the state declaration based on the configuration rules for each definition of the state declaration.

17. The non-transitory computer-readable storage medium of claim 15, wherein the standard format of the state declaration comprises a format associated with a cloud native architecture.

18. The non-transitory computer-readable storage medium of claim 15, wherein the standard format of the state declaration comprises a ConfigMap state declaration.

19. The non-transitory computer-readable storage medium of claim 15, to translate the state declaration to the configuration operations for the target computing system, the processing device is to:
provide the state declaration to a machine learning model trained to infer the set of configuration operations based on statements provided by the state declaration.

20. The non-transitory computer-readable storage medium of claim 15, wherein the target computing system comprises a legacy computing system or a non-cloud native computing system.
